(19) United States
(12) Patent Application Publication
(10) Pub. No.: US 2009/0048630 A1
(43) Pub. Date: Feb. 19, 2009

(54) Child pacifier

(76) Inventor: Dennis L. Davis, Springfield, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/893,379

(22) Filed: Aug. 15, 2007

(51) Int. Cl. A61J 17/00

(52) U.S. Cl. 606/236; 606/234

(57) ABSTRACT

One embodiment of the present invention is a child pacifier comprising a nipple for inserting into a child's mouth, a pacifier housing, the pacifier housing including a plate section adapted to receive the nipple, a spring section, a pacifier middle section coupled to the plate section such that the spring section is positioned between the plate section and the pacifier middle section, a button coupled to the pacifier middle section, the button having an outer face, and at least four shields pivotally coupled to the spring section at a plurality of pivot points, the at least four shields enclosing the nipple when the spring section is disengaged, whereby engaging the spring section causes the at least four shields to pivot about the plurality of pivot points allowing access to the nipple.

### FIELD OF THE INVENTION

The present invention relates to a child pacifier. Specifically, the present invention relates to a child pacifier that closes when not in use, thus protecting the nipple from contact with outside substances and surfaces.

### BACKGROUND OF THE INVENTION

Pacifiers have long been used by infants and children for various reasons. Historically, pacifiers have been used to soothe and quiet infants and to ease teething. Because a pacifier is inserted into a user's mouth, hygiene is an important consideration and many times becomes a problem. A parent does not want their child to ingest or be exposed to dirt, germs, microorganisms, viruses, or other foreign bodies.

When a pacifier is not being used by a child, it is typically stored in a diaper bag, on a table, on a counter, or on the floor. Furthermore, a pacifier may fall out of a child's mouth and onto the floor during use. Also, a child may drop the pacifier out of their hands while using the pacifier. In these situations, the pacifier falls to the floor, being exposed to many outside substances.

The present invention is a pacifier which helps protect the pacifier nipple from coming in contact with dirt, germs, microorganisms, viruses, or other foreign bodies.

### SUMMARY OF THE INVENTION

The present invention solves the above problems by providing a child pacifier.

In one embodiment of the present invention, the present invention is a child pacifier comprising a nipple for inserting into a child's mouth, a pacifier housing, the pacifier housing including a plate section adapted to receive the nipple, a spring section, a pacifier middle section coupled to the plate section such that the spring section is positioned between the plate section and the pacifier middle section, a button coupled to the pacifier middle section, the button having an outer face, and at least four shields pivotally coupled to the spring section at a plurality of pivot points, the at least four shields enclosing the nipple when the spring section is disengaged, whereby engaging the spring section causes the at least four shields to pivot about the plurality of pivot points allowing access to the nipple. An additional embodiment includes a guide arm coupled to each of the at least four shields, where each guide arm is adapted to create a set of two the at least four shields. The set of two of the at least four shields in this additional embodiment pivot simultaneously to enclose or allow access to the nipple. Another embodiment includes a spacer section coupled to the plate section and positioned between the plate section and the spring section. In one embodiment, the plate section and pacifier middle section are cylindrical in shape. In another embodiment, the pacifier housing includes four shields and four pivot points such that two pivot points of the plurality of pivot points are diametrically opposed to two other pivot points of the plurality of pivot points. Another embodiment provides that the plurality of pivot points includes a first and second pair of pivot points such that the first pair of pivot points is opposed to the second pair of pivot points. The pacifier housing may be manufactured from a plastic material. The nipple may be manufactured from a silicone material. In another embodiment, the outer face of the button depicts an animal, an insect, a vegetable, or a plant. In exemplary embodiments, the animal is a dog and the insect is a butterfly.

In another embodiment of the present invention, the present invention is a child pacifier comprising a nipple section adapted to enter a child's mouth, a housing section coupled to the nipple section, a plurality of bottom shields hingedly coupled to the housing section, and a plurality of top shields hingedly coupled to the housing section. The plurality of bottom shields and the plurality of top shields enclose the nipple section in a first position. The plurality of bottom shields and the plurality of top shields allow a child access to the nipple section in a second position. A further embodiment includes an arm coupled to each of the plurality of bottom shields adapted to guide the plurality of top shields from the first position to the second position. Another embodiment includes an arm coupled to each of the plurality of top shields adapted to guide the plurality of bottom shields from the first position to the second position. In another embodiment, the housing section is decorated with or molded to resemble animal, insect, vegetable, or plant designs. In yet another embodiment, the plurality of bottom shields and the plurality of top shields are decorated with or molded to resemble animal, insect, vegetable, or plant designs. In exemplary embodiments, the animal design is a dog and the insect design is a butterfly.

In yet another embodiment of the present invention, the present invention is a method of covering the nipple of a child pacifier, the method comprising the steps of providing a child pacifier having a nipple, a housing section, and four shields, the four shields positioned to allow access to the nipple, engaging at least one of the four shields of the child pacifier, and moving the four shields to a position surrounding the nipple such that access to the nipple is restricted. Yet another embodiment of the present invention is a method of allowing access to the nipple of a child pacifier, the method comprising the steps of providing a child pacifier having a nipple, a housing section, and four shields, the four shields surrounding the nipple to restrict access to the nipple, engaging at least one of the four shields of the child pacifier, and moving the four shields to a position allowing access to the nipple.

From the foregoing disclosure and the following detailed description of various preferred embodiments it will be apparent to those skilled in the art that the present invention provides a significant advance in the art of child pacifiers. Additional features and advantages of various preferred embodiments will be better understood in view of the detailed description provided below.

### BRIEF DESCRIPTION OF THE DRAWINGS

The present invention will be understood and appreciated more fully from the detailed description in conjunction with the following drawings in which:

FIG. 1 is a perspective view of one embodiment of the sanitary child pacifier.

FIG. 2 is a cross-section view of one embodiment of the sanitary child pacifier.

FIG. 3 is another perspective view of one embodiment of the sanitary child pacifier.

FIG. 4 is another cross-section view of one embodiment of the sanitary child pacifier.

FIG. 5 is a perspective view of four shields from one embodiment of the sanitary child pacifier.

It should be understood that the appended drawings are not necessarily to scale, presenting a somewhat simplified representation of various preferred features illustrative of the basic principles of the invention. All references to direction and position, unless otherwise indicated, refer to the orientation of the object illustrated in the drawings.

### DETAILED DESCRIPTION OF THE DRAWINGS

It will be apparent to those skilled in the art that many uses and design variations are possible for the child pacifier disclosed herein. The following detailed discussion of various alternative and preferred embodiments will illustrate the general principles of the invention. Other embodiments will be apparent to those skilled in the art given the benefit of this disclosure.

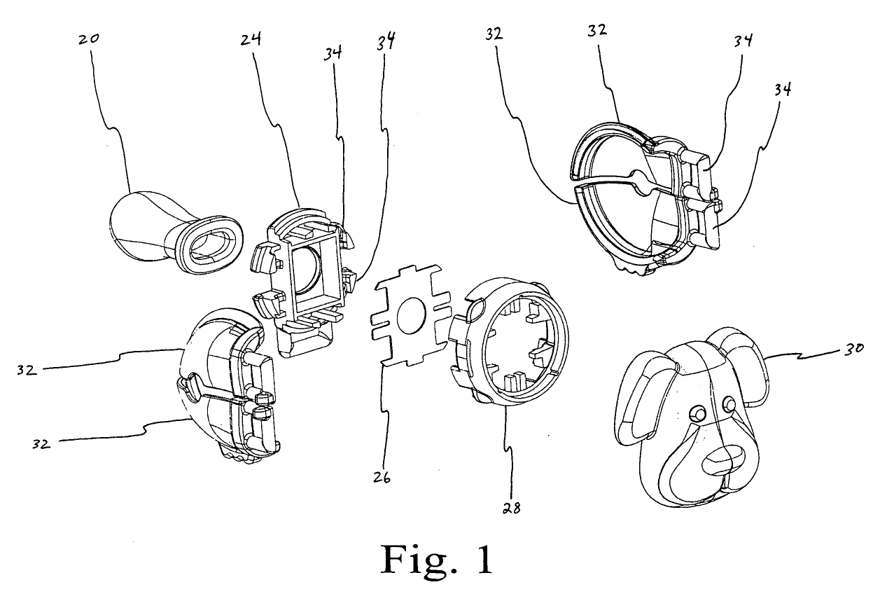

FIG. 1 depicts a perspective view of one embodiment of the sanitary child pacifier. Specifically, this embodiment shows a child pacifier designed to resemble a dog. In this embodiment, the child pacifier includes a nipple 20 and a pacifier housing. The pacifier housing in this embodiment includes a plate section 24, a spring section 26, a pacifier middle section 28, a button 30, and four shields 32. The nipple 20 is designed to be inserted into a child's mouth to soothe, calm, or preoccupy a child. The nipple 20 is coupled to the plate section 24 and may be made of silicone or any other material known in the art. In this embodiment, the plate section 24 includes a hole through which one end of the nipple 20 passes to secure the nipple 20. However, other coupling means may be used to couple the nipple 20 to the plate section 24.

In this embodiment, the spring section 26 is located between the plate section 24 and the pacifier middle section 28. Each of the four shields 32 is pivotally coupled to the spring section 26 at discrete pivot points 34. This pivotal coupling may be a hinge that couples the spring section 26 to the shields 32. In this embodiment, the spring section 26 is engaged and disengaged by applying force to the four shields 32 to pivot the shields 32 about the pivot points 34. To disengage the spring section 26, a user would pivot the shields 32 away from the button 30. To engage the spring section 26, a user would pivot the shields 32 toward the button 30. When the spring section 26 is disengaged, the four shields 32 are positioned such that the nipple 20 is surrounded by the shields 32 and access to the nipple 20 is prohibited. When the spring section 26 is engaged, the shields 32 allow a child access to the nipple 20.

In another embodiment, the shields 32 may include guide arms such that the four shields 32 are effectively divided into pairs. Guide arms are members or appendages extending from the shield 32. In this manner, each of the shields 32 connected by guide arms move simultaneously about their pivot points 34. For example, consider a pacifier having four shields 32 named A, B, C, and D. Each of these shields 32 has a guide arm. The guide arm of A is positioned to guide shield B and the guide arm of B is positioned to guide shield A. When shield A pivots about its pivot point 34, the movement causes shield B to pivot about its pivot point 34. Similarly, when shield B pivots about its pivot point 34, the movement causes shield A to pivot about its pivot point 34. Therefore, the guide arms of shields A and B create simultaneous movement of both shields A and B. This is also true of shields C and D. Even though shields A, B, C, and D are individual shields 32, shields A and B move as one shield and shields C and D move as one shield.

Coupled to the pacifier middle section 28 is a button 30. This button 30 includes an outer face which may be decorated, painted or molded. In this embodiment, the outer face of the button 30 is molded to resemble a dog. Other embodiments may be decorated, painted, or molded to resemble other animals, insects, vegetables, or plants. In other embodiments, the outer face may not be decorated at all.

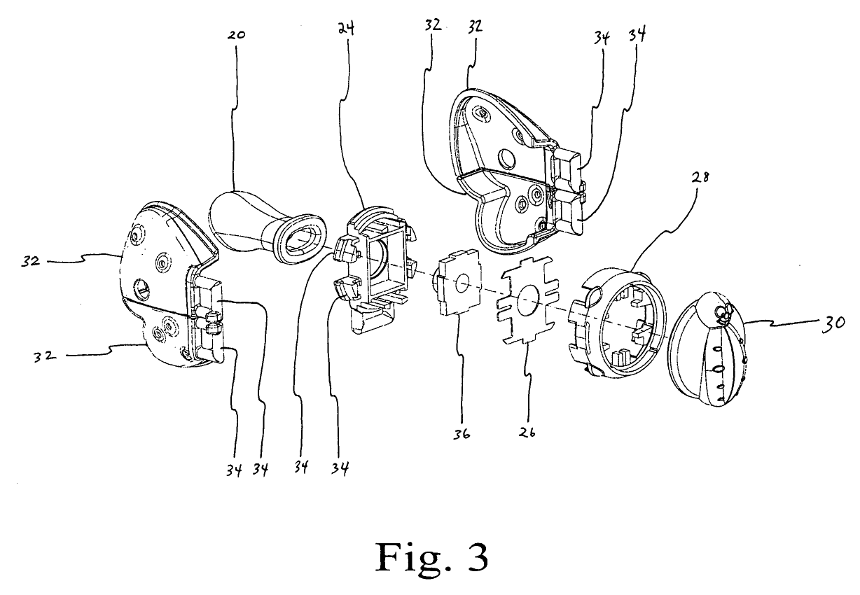

FIG. 3 depicts a perspective view of one embodiment of the sanitary child pacifier. Specifically, this embodiment shows a child pacifier designed to resemble a butterfly. In this embodiment, the child pacifier includes a nipple 20 and a pacifier housing. The pacifier housing in this embodiment includes a plate section 24, a spacer section 36, a spring section 26, a pacifier middle section 28, a button 30, and four shields 32. Similar to the embodiment of FIG. 1, the plate section 24 includes a hole through which one end of the nipple 20 passes to secure the nipple 20. However, other coupling means may be used to couple the nipple 20 to the plate section 24. The spacer section 36 is positioned between the plate section 24 and the spring section 26. The spring section 26 is located between the spacer section 36 and the pacifier middle section 28.

Each of the four shields 32 is pivotally coupled to the spring section 26 at discrete pivot points 34. This pivotal coupling may be a hinge that couples the spring section 26 to the shields 32. In this embodiment, the spring section 26 is engaged and disengaged by applying force to the four shields 32 to pivot the shields 32 about the pivot points 34. To disengage the spring section 26, a user would pivot the shields 32 away from the button 30. To engage the spring section 26, a user would pivot the shields 32 toward the button 30. When the spring section 26 is disengaged, the four shields 32 are positioned such that the nipple 20 is surrounded by the shields 32 and access to the nipple 20 is prohibited. When the spring section 26 is engaged, the shields 32 allow a child access to the nipple 20.

In an exemplary embodiment, the plate section 24, spring section 26, and pacifier middle section 28 are cylindrical in shape. This cylindrical shape allows for shield pivot points 34 to be diametrically opposed to one another. For example, a pacifier may have shields W, X, Y, and Z. At one point 34 on the cylindrical spring section 26, shield W pivots about a pivot point 34. Shield X pivots about a nearby pivot point 34. Directly opposed to shields W and X, shields Y and Z also have pivot points 34 near each other. The pivot points 34 are positioned such that the pivot point 34 for shield W diametrically opposes the pivot point 34 for shield Y. Also, the pivot point 34 for shield X diametrically opposes the pivot point 34 for shield Z. In another embodiment, a first and second pair of pivot points 34 exist such that the first pair of pivot points 34 is opposed to the second pair of pivot points 34. In the above example, shields W and X pivot about the first pair of pivot points 34 and Y and Z pivot about the second set of pivot points 34.

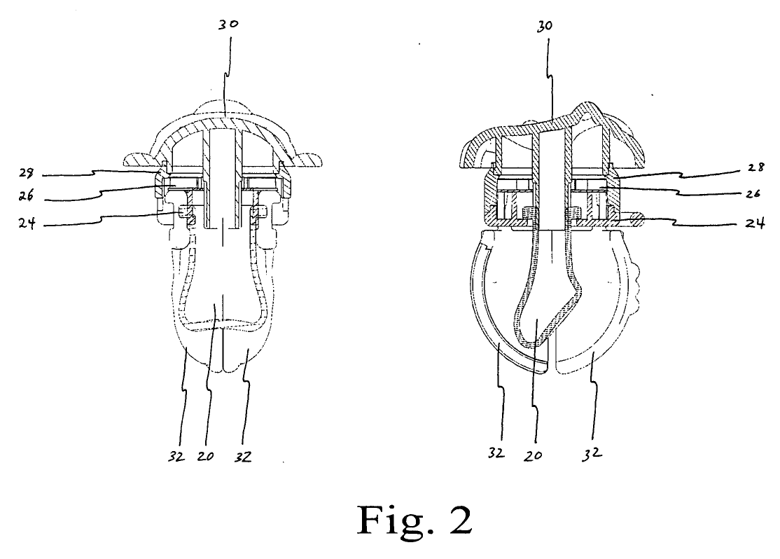

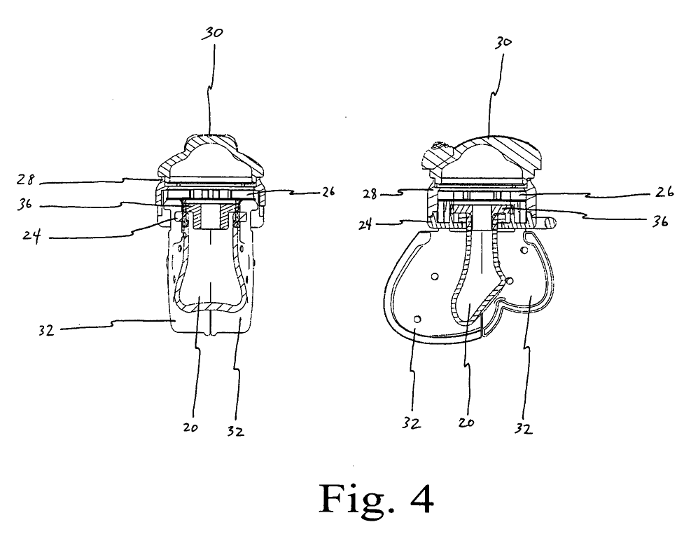

FIGS. 2 and 4 depict cross-section views of different embodiments of the child pacifier. In both Figures, the spring section 26 is disengaged and the nipple 20 is enclosed. FIG. 2 shows an embodiment molded to resemble a dog. FIG. 4 shows an embodiment molded to resemble a butterfly. The decorations or moldings do not affect the operation of the pacifier.

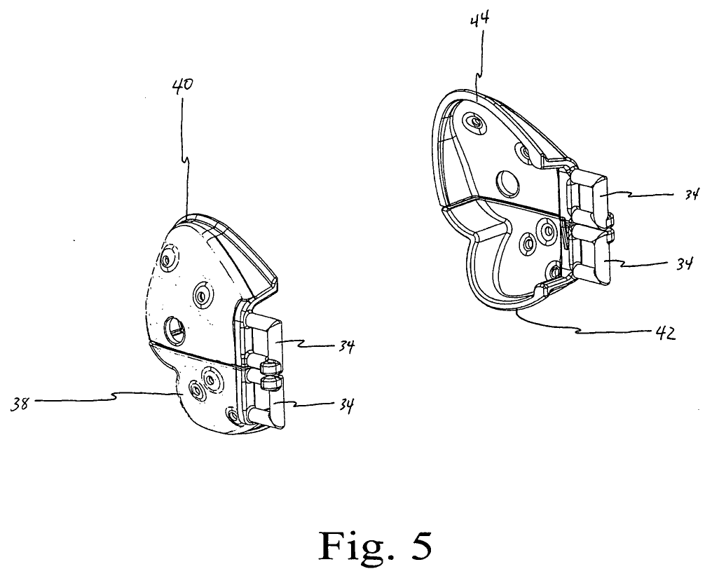

FIG. 5 depicts a perspective view of four shields from one embodiment of the sanitary child pacifier. Guide arms may be added to each of the shields in FIG. 5 such that the pair of shields 38 and 40 may be pivoted simultaneously and shields 42 and 44 are paired to pivot simultaneously. The pair containing shields 38 and 40 would move independently of the pair containing shields 42 and 44.

All components of the pacifier housing including the plate section 24, spring section 26, spacer section 36, pacifier middle section 28, button 30, and four shields 32 may be manufactured from a plastic material such as polypropylene or any other material known in the art.

The apparatuses, uses, and methods disclosed herein have been described without reference to specific hardware. However, the apparatuses, uses, and methods disclosed herein have been described in a manner sufficient to enable persons of ordinary skill in the art to readily adapt commercially available hardware as may be needed to reduce any of the embodiments of the present invention to practice without undue experimentation.

It will be appreciated by persons skilled in the art that the present invention is not limited to what has been particularly shown and described in herein. The scope of the present invention is defined only by the claims which follow.

What is claimed is:

1. A child pacifier comprising:
a nipple for inserting into a child's mouth;
a pacifier housing, the pacifier housing including
a plate section adapted to receive the nipple;
a spring section;
a pacifier middle section coupled to the plate section such that the spring section is positioned between the plate section and the pacifier middle section;
a button coupled to the pacifier middle section, the button having an outer face; and
at least four shields pivotally coupled to the spring section at a plurality of pivot points, the at least four shields enclosing the nipple when the spring section is disengaged;
whereby engaging the spring section causes each of the at least four shields to pivot about one of the plurality of pivot points allowing access to the nipple.

2. The child pacifier of claim 1, further comprising:
a guide arm coupled to each of the at least four shields, each guide arm adapted to create a set of two the at least four shields;
whereby the set of two of the at least four shields pivot simultaneously to enclose or allow access to the nipple.

3. The child pacifier of claim 1, further comprising:
a spacer section coupled to the plate section and positioned between the plate section and the spring section.

4. The child pacifier of claim 1, wherein
the plate section, spring section, and pacifier middle section are cylindrical in shape.

5. The child pacifier of claim 4, wherein
the pacifier housing includes four shields and four pivot points such that two pivot points of the plurality of pivot points are diametrically opposed to two other pivot points of the plurality of pivot points.

6. The child pacifier of claim 1, wherein
the plurality of pivot points includes a first and second pair of pivot points such that the first pair of pivot points is opposed to the second pair of pivot points.

7. The child pacifier of claim 1, wherein the pacifier housing is manufactured from a plastic material.

8. The child pacifier of claim 1, wherein the nipple is manufactured from a silicone material.

9. The child pacifier of claim 1, wherein the outer face of the button depicts an animal, an insect, a vegetable, or a plant.

10. The child pacifier of claim 9, wherein the animal is a dog.

11. The child pacifier of claim 9, wherein the insect is a butterfly.

12. A child pacifier comprising:
a nipple section adapted to enter a child's mouth;
a housing section coupled to the nipple section;
a plurality of bottom shields hingedly coupled to the housing section; and
a plurality of top shields hingedly coupled to the housing section;
wherein the plurality of bottom shields and the plurality of top shields enclose the nipple section in a first position;
wherein the plurality of bottom shields and the plurality of top shields allow a child access to the nipple section in a second position.

13. The child pacifier of claim 12, further comprising:
an arm coupled to each of the plurality of bottom shields adapted to guide the plurality of top shields from the first position to the second position.

14. The child pacifier of claim 12, further comprising:
an arm coupled to each of the plurality of top shields adapted to guide the plurality of bottom shields from the first position to the second position.

15. The child pacifier of claim 12, wherein the housing section is decorated with or molded to resemble animal, insect, vegetable, or plant designs.

16. The child pacifier of claim 12, wherein the plurality of bottom shields and the plurality of top shields are decorated with or molded to resemble animal, insect, vegetable, or plant designs.

17. The child pacifier of claim 15, wherein the animal design is a dog.

18. The child pacifier of claim 15, wherein the insect design is a butterfly.

19. A method of covering the nipple of a child pacifier, the method comprising the steps:
providing a child pacifier having a nipple, a housing section, and four shields, the four shields positioned to allow access to the nipple;
engaging at least one of the four shields of the child pacifier; and
moving the four shields to a position surrounding the nipple such that access to the nipple is restricted.

20. A method of allowing access to the nipple of a child pacifier, the method comprising the steps:
providing a child pacifier having a nipple, a housing section, and four shields, the four shields surrounding the nipple to restrict access to the nipple;
engaging at least one of the four shields of the child pacifier; and
moving the four shields to a position allowing access to the nipple.
